(19) United States
(12) Patent Application Publication
(10) Pub. No.: US 2008/0083801 A1
(43) Pub. Date: Apr. 10, 2008

(54) MOTORCYCLE SADDLEBAG MOUNTING SYSTEM

(75) Inventors: Frederich H. Knoch, Racine, WI (US); Adam J. Shileny, West Bend, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/869,259

(22) Filed: Oct. 9, 2007

Related U.S. Application Data
(60) Provisional application No. 60/849,880, filed on Oct. 9, 2006.

(51) Int. Cl. B62J 9/00

(52) U.S. Cl. 224/413; 180/311

(57) ABSTRACT

A saddlebag mounting system for use with a motorcycle having a frame. The saddlebag mounting system includes a saddlebag frame and a saddlebag. The saddlebag frame is configured to be coupled to the frame of the motorcycle, and the saddlebag frame includes a saddlebag attachment portion. The saddlebag includes a body having a plurality of walls that define a cavity, and a pocket on at least one of the plurality of walls. The pocket receives at least a portion of the saddlebag attachment portion to couple the saddlebag to the saddlebag frame.

### RELATED APPLICATIONS

This application claims priority to U.S. Provisional Patent Application Ser. No. 60/849,880 filed on Oct. 9, 2006, the entire contents of which is incorporated herein by reference.

### BACKGROUND

The present invention relates to motorcycles, and more particularly to saddlebag mounting systems for motorcycles.

Motorcycles can include saddlebags that are used by the rider of the motorcycle to store items on the motorcycle. Saddlebags are commonly mounted to saddlebag frames. The saddlebags and saddlebag frames are typically secured to opposing sides of the motorcycle. The saddlebags can be mounted to the saddlebag frames to permit removal of the saddlebags from the motorcycle in order to change the appearance of the motorcycle and to allow the user to transport items away from the motorcycle in the saddlebags.

### SUMMARY

In one embodiment, the invention provides a saddlebag mounting system for use with a motorcycle having a frame. The saddlebag mounting system includes a saddlebag frame and a saddlebag. The saddlebag frame is configured to be coupled to the frame of the motorcycle, and the saddlebag frame includes a saddlebag attachment portion. The saddlebag includes a body having a plurality of walls that define a cavity, and a pocket on at least one of the plurality of walls. The pocket receives at least a portion of the saddlebag attachment portion to couple the saddlebag to the saddlebag frame.

In another embodiment the invention provides a motorcycle having the saddlebag that includes the pocket that receives at least a portion of the saddlebag attachment portion to couple the saddlebag to the saddlebag frame.

In yet another embodiment the invention provides a saddlebag for use with a saddlebag frame having an attachment portion and configured to be coupled to a frame of a motorcycle. The saddlebag includes a body having a plurality of walls that define a cavity, and a pocket on at least one of the plurality of walls. The pocket is configured to receive at least a portion of the saddlebag attachment portion to couple the saddlebag to the saddlebag frame.

Other aspects of the invention will become apparent by consideration of the detailed description and accompanying drawings.

### BRIEF DESCRIPTION OF THE DRAWINGS

FIG. 1 is a perspective view of a motorcycle that includes a saddlebag mounting system embodying the present invention.

FIG. 2 is an exploded view of the saddlebag mounting system and a portion of the motorcycle of FIG. 1.

FIG. 3 is a rear perspective view of the saddlebag mounting system of FIG. 1.

FIG. 4 is a partially exploded rear perspective view of the saddlebag mounting system of FIG. 1.

FIG. 5 is a perspective view of a portion of the motorcycle of FIG. 1 with saddlebags of the saddlebag mounting system removed.

FIG. 6 is a cross section of a portion of the motorcycle and saddlebag mounting system taken along line 6-6 of FIG. 1.

FIGS. 7a and 7b are enlarged views of portions of the saddlebag shown in FIG. 6.

FIG. 8 is an enlarged perspective view of a portion of the motorcycle of FIG. 1 illustrating an alternative method of utilizing the saddlebag mounting system.

FIG. 9 is partially exploded rear perspective view of an alternative construction of the saddlebag mounting system of FIG. 1.

FIG. 10 is a rear perspective view of an alternative construction of the saddlebag mounting system of FIG. 1.

FIG. 11 is a side view of the saddlebag mounting system of FIG. 10 with a first frame member removed.

FIG. 12 is a side view of the saddlebag mounting system of FIG. 10 with the first frame member removed and illustrating one securing member fastened and one securing member unfastened.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

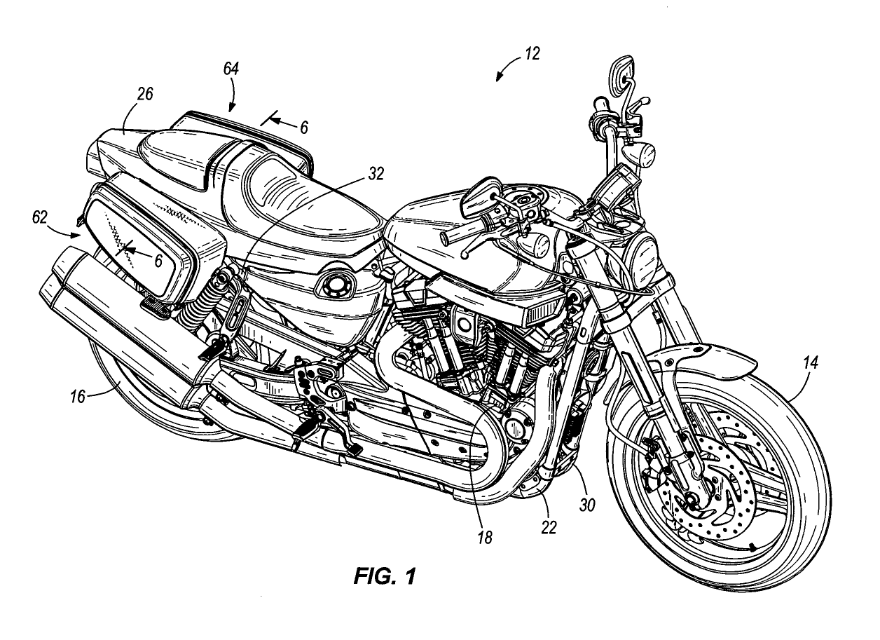

FIG. 1 illustrates a motorcycle 12 that includes a front wheel 14, a rear wheel 16, and an engine assembly 18 located between the front and rear wheels 14, 16. The motorcycle 12 further includes a frame 22 and a seat assembly 26 that is supported by the frame 22.

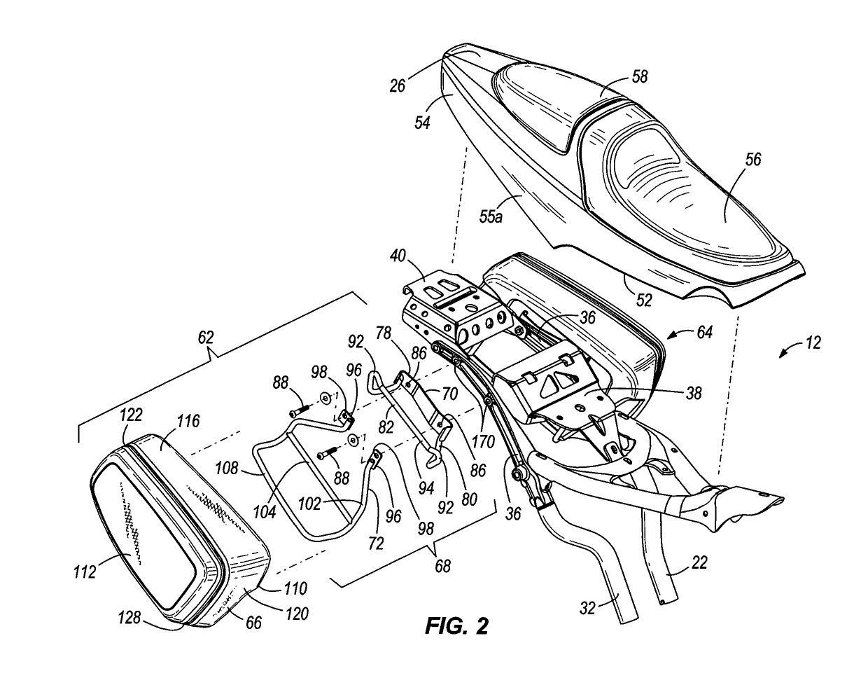

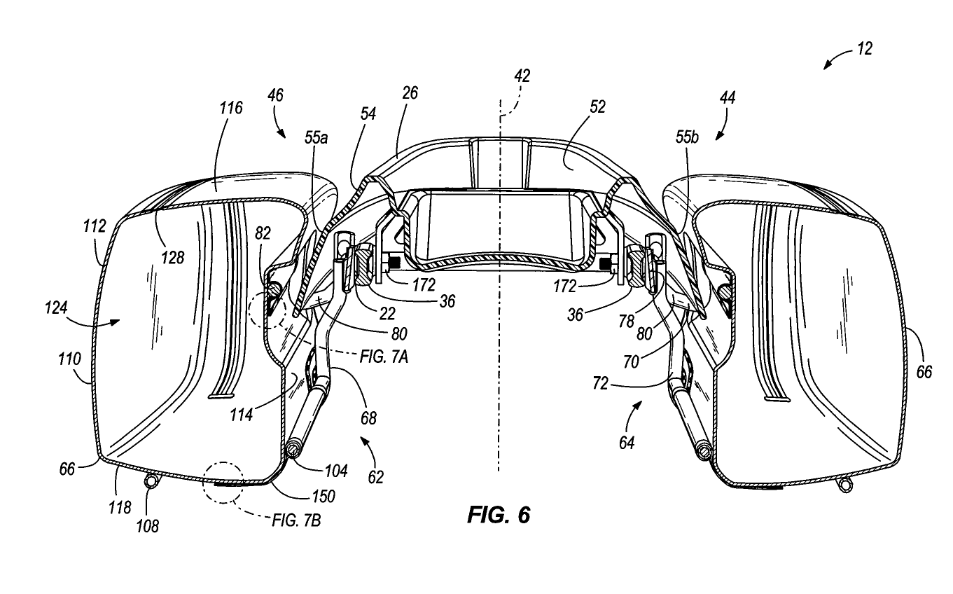

Referring to FIG. 1, the frame 22 defines a front portion 30 located adjacent the front wheel 14 and a rear portion 32 located adjacent the rear wheel 16. Referring to FIG. 2, the rear portion 32 of the frame 22 includes rear fender supports 36. A seat support bracket 38 and a rear fender support bracket 40 are coupled to the rear fender supports 36. As best seen in FIG. 6, the frame 22 defines a frame plane 42 that extends longitudinally generally through the center of the frame 22 to divide the frame 22 into a left side portion 44 and a right side portion 46.

Referring to FIG. 2, the seat assembly 26 includes a seat pan 52 having a rear fender 54 having side walls 55a and 55b (see, FIG. 6). While in the illustrated construction the rear fender 54 is integrally formed with the seat pan 52, in other constructions, the rear fender and the seat pan can be separate components.

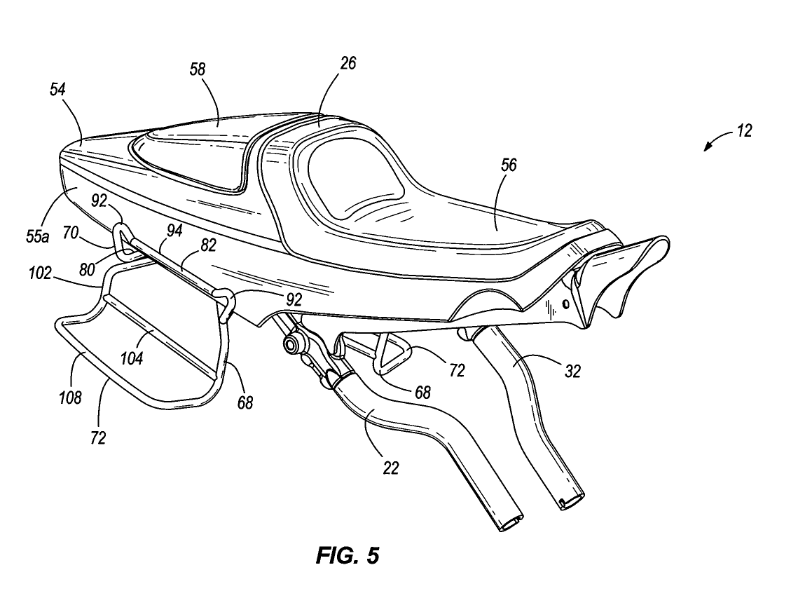

The seat assembly 26 further includes a front seat 56 and a rear seat 58 that are supported by and coupled to the seat pan 52. The seat assembly 26 is coupled to the frame 22 of the motorcycle 12 such that the frame 22, the seat support bracket 38, and the rear fender support bracket 40 provide support for the seat assembly 26. As best seen in FIGS. 5 and 6, when the seat assembly 26 is coupled to the motorcycle 12, the side walls 55a and 55b of the rear fender 54 substantially cover the rear fender supports 36 in order that the rear fender supports 36 are generally not visible from the side of the motorcycle 12. In order to view the rear fender supports 36 when the seat assembly 26 is coupled to the motorcycle 12, one would generally need to look upwardly from underneath the seat assembly 26.

Referring to FIGS. 1 and 6, the motorcycle 12 further includes a first saddlebag mounting system 62 coupled to the right side 46 of the motorcycle fame 22 and a second saddlebag mounting system 64 coupled to the left side 44 of the motorcycle frame 22. The first and second saddlebag mounting systems 62, 64 are substantially the same. Therefore, only the first saddlebag mounting system 62 will be described in detail below and similar components of the saddlebag mounting systems 62, 64 are given the same reference numbers.

Referring to FIG. 2, the saddlebag mounting system 62 includes a saddlebag 66 and a saddlebag frame 68. The saddlebag frame 68 includes a first frame member 70 and a second frame member 72. The first frame member 70 includes a mounting portion 78, an extension portion 80, and a saddlebag attachment portion 82.

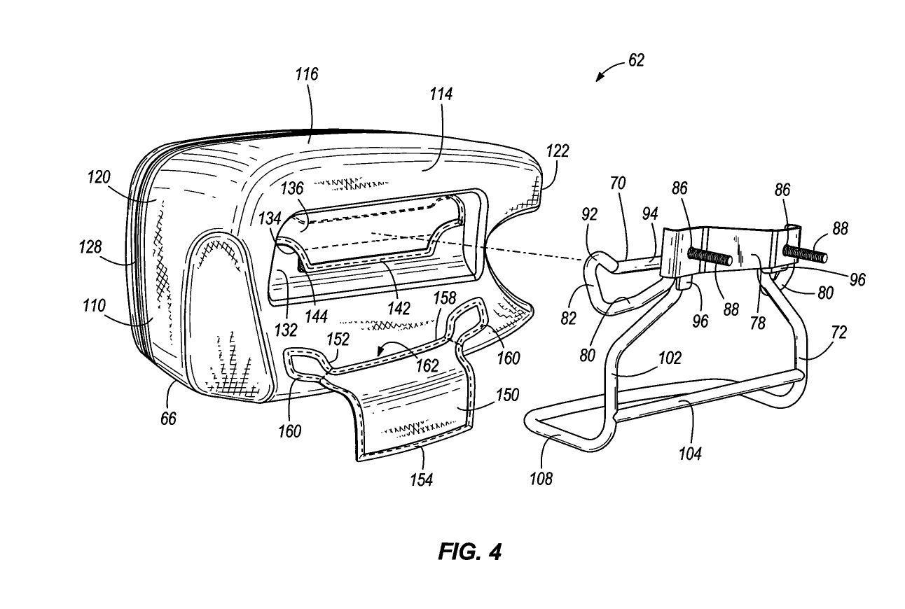

Referring to FIGS. 2 and 4, the mounting portion 78 includes mounting apertures 86 that each receive a fastener 88. As best seen in FIG. 4, the apertures 86 each extend through substantially planar portions of the mounting portion 78, which are offset such that the mounting apertures 86 lie in vertical planes that are offset.

The extension portion 80 is coupled to and extends outwardly (i.e., in a direction away from the central plane 42 of the motorcycle frame 22, see FIG. 6) from the mounting portion 78 when the saddlebag frame 68 is coupled to the motorcycle frame 22. The saddlebag attachment portion 82 is integrally formed with and extends upwardly from the extension portion 80. The illustrated saddlebag attachment portion 82 includes raised end portions 92 and a generally straight member 94 that extends between the raised end portions 92.

The second frame member 72 includes mounting brackets 96 that each include a mounting aperture 98. The mounting apertures 98 are spaced a distance such that the mounting apertures 98 of the second frame member 72 substantially align with the mounting apertures 86 of the first frame member 70 such that the apertures 86, 89 receive the fasteners 88. The second frame member 72 further includes an extension portion 102 and a saddlebag attachment portion 104. The extension portion 102 extends generally downwardly from the mounting brackets 96 to the attachment portion 104. The illustrated attachment portion 104 of the second frame member 72 is a generally straight member that extends between the extension portion 102.

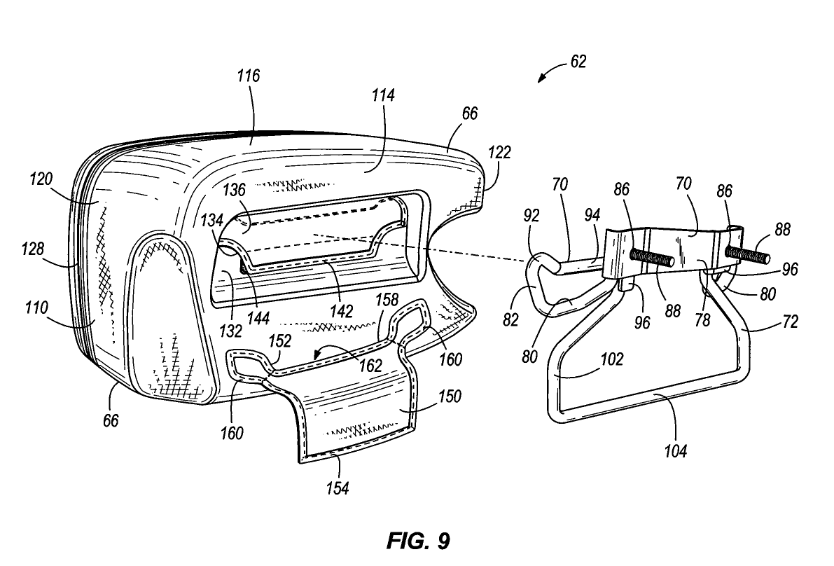

The illustrated second frame member 72 further includes a saddlebag support member 108 that extends outwardly and downwardly from the attachment portion 102. As illustrated in FIG. 9, in other constructions, the second frame member 72 may omit the saddlebag support member 108 of the second frame member 72.

Referring to FIGS. 2 and 6, the saddlebag 66 includes a body portion 110 defined by a front wall 112, a rear wall 114, a top wall 116, a bottom wall 118, a forward wall 120 and a rearward wall 122. The walls 112, 114, 116, 118, 120, 122 define a cavity 124. A fastening mechanism 128, which is a zipper in the illustrated construction, is utilized to access the cavity 124.

In one construction, the walls 112, 114, 116, 118, 120, 122 are formed from a substantially ridged base material such that the saddlebag 66 maintains the shape illustrated in FIG. 1. A fabric material is bonded to the ridged base material to aesthetically enhance the visual appearance of the saddlebag 66.

Referring to FIG. 4, the rear wall 114 of the saddlebag 66 defines a recessed portion 132. A downwardly opening pocket 134 is located within the recessed portion 132. The pocket 134 is formed by a flap 136 and the rear wall 114. In the illustrated construction, the flap 136 is formed from a fabric material and is coupled to the rear wall 114 such as by bonding, stitching, fastening, etc. In other constructions, the flap can be formed from a rigid or semi-rigid material. In yet other constructions, the flap can be formed from fabric and reinforced with rigid or semi-rigid materials.

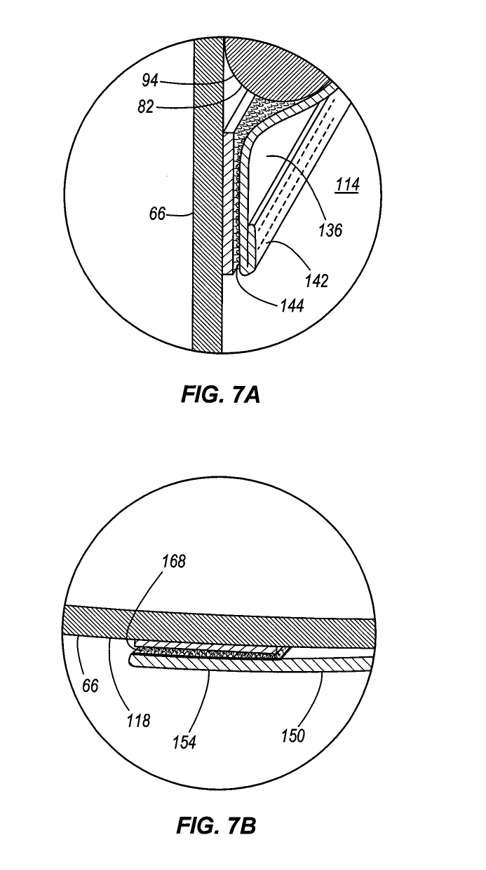

Referring to FIGS. 4 and 7a, the flap 136 includes a free end portion 142 having a pocket fastening system 144. The illustrated pocket fastening system 144 is a hook and loop fastener system, such as VELCRO, and the free end portion 142 includes one portion of the pocket fastening system 144 and the rear wall 114 includes a corresponding portion of the pocket fastening system 144.

Referring to FIG. 4, the pocket 134 is elongated such that the pocket 134 extends along a substantial length of the rear wall 114 between the forward and rearward walls 120, 122 of the saddlebag 66. In the illustrated construction, the pocket 134 extends along approximately 75 percent of the length of the rear wall 114. In other constructions, the pocket can extend along at least about one quarter of the length of the rear wall 114, and in yet other constructions the pocket can extend along any suitable length of the rear wall 114.

With continued reference to FIG. 4, the rear wall 114 of the saddlebag 66 further includes a securing member 150. In the illustrated construction, the securing member 150 is a flexible fabric strap that includes a fixed end portion 152 and a free end portion 154. The fixed portion 152 includes a central portion 158 and enlarged portions 160 at each end of the central portion 158. The enlarged portions 160 are secured to the saddlebag 66, such as by stitching, bonding and the like, and the central portion 158 generally is not directly secured to the saddlebag such that an aperture 162 is located between the central portion 158 and the rear wall 114 of the saddlebag 66.

As best seen in FIGS. 6 and 7b, the free end portion 154 of the securing member 150 includes a portion of a fastener 168, which, in the illustrated construction, is a hook and loop fastener system, such as VELCRO. The bottom wall 118 of the saddlebag 66 includes a second portion of the fastening system 168 such that the free end portion 154 of the securing member 150 can be secured to the bottom wall 118 of the saddlebag 66.

Referring to FIGS. 2 and 4, to assemble the saddlebag mounting system 62 with the motorcycle 12, the mounting apertures 98 of the second frame member 72 are aligned with the mounting apertures 86 of the first frame member 70. Then, the fasteners 88 are inserted through the mounting apertures 86, 98 of the first and second frame member 70, 72, respectively, to couple the first and second frame members 70, 72.

Referring to FIGS. 2 and 6, the fasteners 88 are then inserted through mounting apertures 170 of the rear fender support bracket 36. In the illustrated construction, the fasteners 88 are bolts. Therefore, a nut 172 is threaded onto each fastener 88 to secure the first and second frame members 70, 72 to the rear fender support 36 of the motorcycle frame 22.

Referring to FIGS. 2, 5, and 6, the mounting portion 78 of the saddlebag frame 68 and the fasteners 88 that couple the saddlebag frame 68 to the motorcycle frame 22 are generally not visible from the side of the motorcycle 12 because the rear fender supports 36 are covered by the rear fender 54.

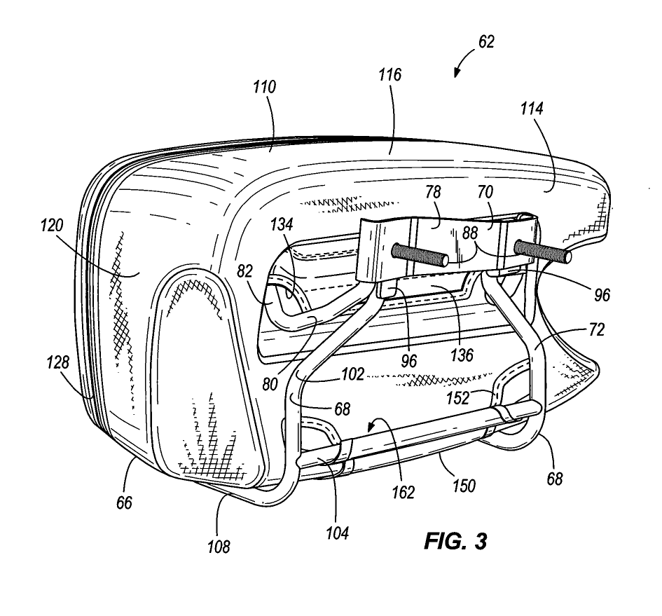

Referring to FIGS. 3 and 6, the saddlebag 66 is secured to the saddlebag frame 68 by inserting the upstanding attachment portion 82 of the saddlebag frame 68 into the downwardly opening pocket 134. As best seen in FIG. 7a, the pocket fastening system 144 is utilized to secure the free end 142 to the rear wall 114 of the saddlebag 66, and thereby substantially securing the saddlebag 66 to the frame 68.

Referring to FIG. 6, when the attachment portion 82 of the first saddlebag frame member 70 is inserted into the pocket 134, the bottom wall 118 of the saddlebag 66 contacts the saddlebag support 108. The saddlebag support 108 supports the saddlebag 66 from the bottom and thereby inhibits rotation of the saddlebag 66 about the attachment portion 82 of the first saddlebag frame member 70.

Referring to FIGS. 3, 4, and 6, the securing member 150 of the saddlebag 66 is wrapped around the attachment portion 104 of the second saddlebag frame member 72 and the free end 154 of the securing member 150 is threaded through the aperture 162. Then, the free end 154 is secured to the bottom wall 118 of the saddlebag 66 using the fastening system 168 (FIG. 7b).

The saddlebag 66 can easily be removed from the saddlebag frame 68 by unfastening the free end 154 of the securing member 150 from the bottom wall 118 of the saddlebag 66 by separating the fastening system 168. Then, the securing member 150 is unthreaded through the aperture 162 and unwrapped from around the attachment portion 104 of the second saddlebag frame member 72. The free end 142 of the pocket 134 is unsecured from the rear wall 114 of the saddlebag 66 by pulling apart the hook and loop fastening system 144. Next, the saddlebag 66 can be removed from the saddlebag frame 68 by lifting the saddlebag 66 upwardly to remove the attachment portion 82 of the first saddlebag frame member 72 from the pocket 134.

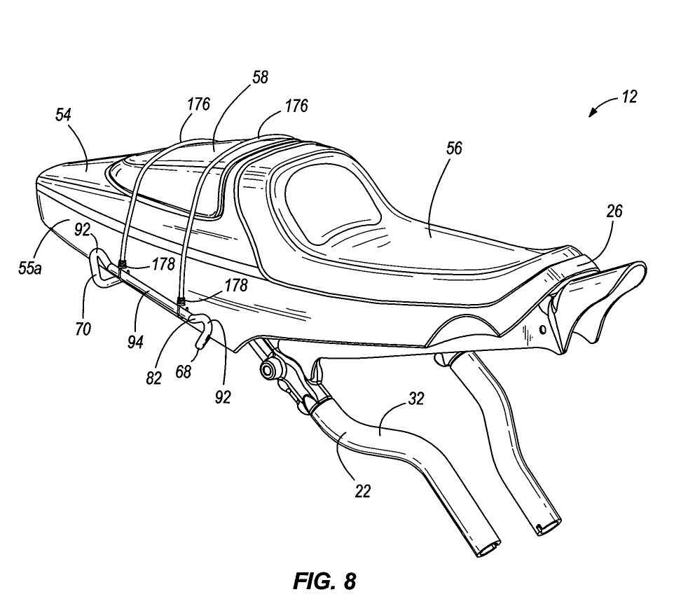

Referring to FIG. 8, with the saddlebags 66 removed from the saddlebag frames 68, the saddlebag frames 68 can be used to couple a cargo securing device 176 to the motorcycle 12. In the illustrated construction, the cargo securing device 176 includes two elastic chords with hooks 178. The hooks 178 couple the cargo securing devices 176 to the saddlebag attachment portions 82 of the first saddlebag frame members 70. In other constructions, the cargo securing device can include any suitable device, such as cargo nets, a single elastic chord, multiple elastic chords, and the like. While not illustrated, cargo can be placed between the rear seat 58 and the cargo securing device 176 to secure the cargo to the motorcycle 12. As seen in FIG. 8, when the cargo securing device 176 is utilized, the second frame member 72 (FIG. 4) can be removed such that just the first frame member 70 of the saddlebag frame 68 is coupled to the motorcycle 12.

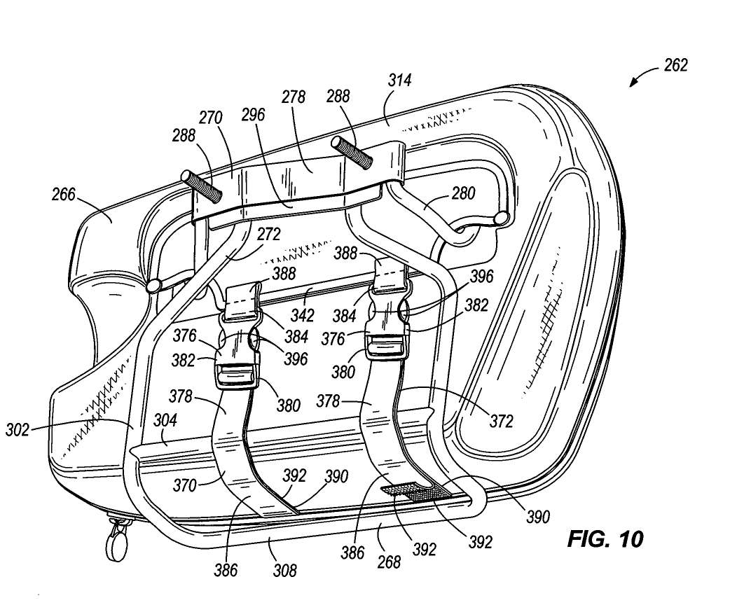

FIGS. 10-12 illustrate an alternative construction of the saddlebag mounting system 62 of FIGS. 1-9. The saddlebag mounting system 262 of FIGS. 10-12 is substantially similar to the saddlebag mounting system 62 of FIGS. 1-9. Therefore, only the general differences will be discussed in detail below and like components have been given like references numbers plus two-hundred.

The saddlebag 266 of FIGS. 10-12 omits the flexible fabric strap securing member 150 of the saddlebag mounting system 66 of FIGS. 1-9. Rather, the saddlebag 266 includes a first securing member 370 and a second securing member 372. The first and second securing members 370 and 372 are generally the same and therefore only the first securing member 370 will be discussed in detail and like components have been given like reference numbers.

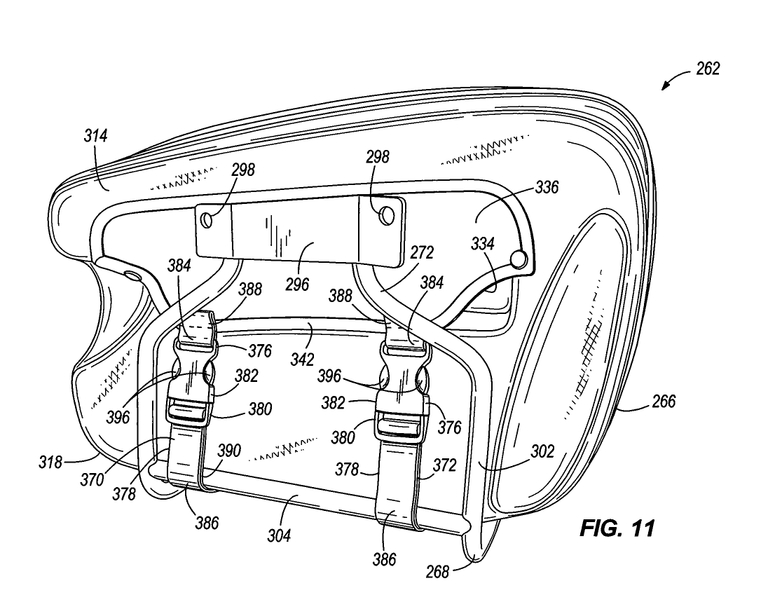

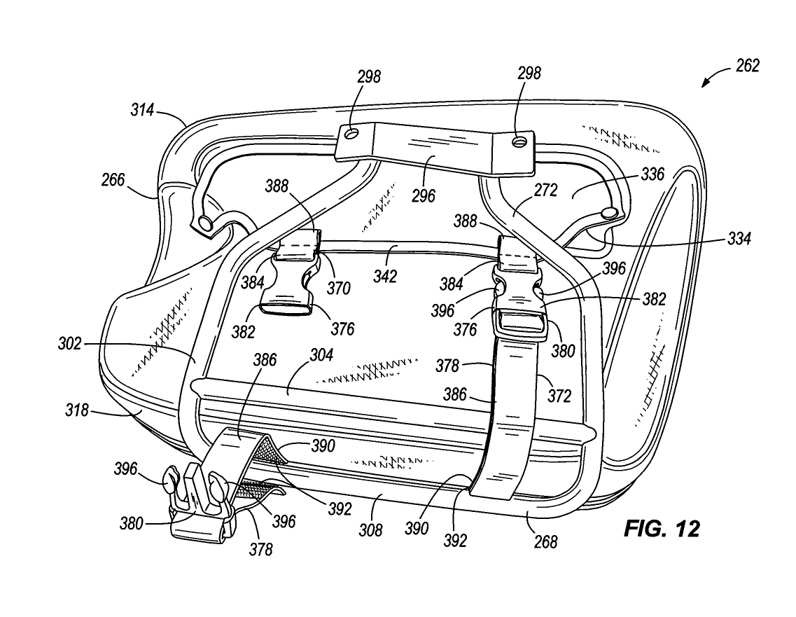

Referring to FIGS. 11 and 12, the first securing member 370 includes a clip 376 and a flexible strap 378. The clip 376 includes a first portion 380 and a second portion 382 that receives the first portion 380 to secure the saddlebag 266 to the saddlebag frame 268. The strap 378 includes a first portion 384 and a second portion 386. The first portion 384 includes a fixed end 388 that is directly coupled to the free end 342 of the flap 336. The second portion 386 of the strap 378 includes a fixed end 390 that is directly coupled to the bottom wall 318 of the saddlebag 266.

As best seen in FIG. 12, the second portion 386 of the strap 378 further includes a fastening system 392. The illustrated fastening system 392 is a hook and loop fastening system, such as VELCRO, and is utilized to secure the second portion 386 of the strap 378 to the bottom wall 318 of the saddlebag 266.

FIG. 12 illustrates the clip 376 of the first securing member 370 in an unclipped or released position and the clip 376 of the second securing member 372 in a clipped or fastened position. As would be understood by one skill in the art, the first and second portions 380 and 382 of the clip 376 are unclipped by depressing tabs 396 of the first portion 380 and removing the first portion 380 from within the second portion 382. When the clips 376 are unclipped, the saddlebag 266 can be removed from the saddlebag frame 268.

Referring to FIG. 10 when the clips 376 are in the clipped position, the straps 378 of the first and second securing members 370 and 372 retain the attachment portion 304 of the second saddlebag frame member 272 between the straps 378 and the body 310 of the saddlebag 266. Furthermore, the second portion 386 of the strap 378 can be pulled generally downwardly to tighten the strap 378 to further secure the saddlebag 266 to the saddlebag frame 268.

Various features and advantages of the invention are set forth in the following claims.

What is claimed is:

1. A saddlebag mounting system for use with a motorcycle having a frame, the saddlebag mounting system comprising:
a saddlebag frame configured to be coupled to the frame of the motorcycle, the saddlebag frame including a saddlebag attachment portion; and
a saddlebag including a body having a plurality of walls that define a cavity, and a pocket on at least one of the plurality of walls, the pocket receiving at least a portion of the saddlebag attachment portion to couple the saddlebag to the saddlebag frame.

2. The saddlebag mounting system of claim 1, wherein the saddlebag attachment portion is a first saddlebag attachment portion, and wherein the saddlebag frame further includes a second saddlebag attachment portion, and wherein the saddlebag further includes a securing member coupled to the second saddlebag attachment portion to couple the saddlebag to the saddlebag frame.

3. The saddlebag mounting system of claim 2, wherein the securing member includes a strap to be wrapped at least partially around a portion of the second saddlebag attachment portion of the saddlebag frame.

4. The saddlebag mounting system of claim 3, wherein the securing member further includes a clip to releaseably couple the saddlebag to the saddlebag frame.

5. The saddlebag mounting system of claim 4, wherein the pocket includes a flap, wherein a first end of the securing member is coupled to the pocket, wherein a second end of the securing member includes a hook and loop fastener system to at least partially secure the second end of the securing member to the saddlebag, and wherein the clip is positioned between the first end of the securing member and the second end of the securing member.

6. The saddlebag mounting system of claim 5, wherein the flap is substantially formed from a fabric material.

7. The saddlebag mounting system of claim 2, wherein the saddlebag frame includes a first member and a second member removably coupled to the frame of the motorcycle, and wherein the first member includes the first saddlebag attachment portion and the second member includes the second saddlebag attachment portion.

8. The saddlebag mounting system of claim 7, further comprising a fastener configured to couple the saddlebag frame to the frame of the motorcycle, wherein the first member includes a mounting aperture that receives the fastener, wherein the second member includes a mounting aperture that aligns with the mounting aperture of the first member and receives the fastener to couple the first and second frame members to the frame of the motorcycle.

9. The saddlebag mounting system of claim 1, wherein the saddlebag attachment portion of the saddlebag frame is configured to extend upwardly when then saddlebag frame is coupled to the motorcycle.

10. The saddlebag mounting system of claim 9, wherein the saddlebag attachment portion of the saddlebag frame includes raised end portions and a generally straight member extending between the raised end portions.

11. The saddlebag mounting system of claim 9, wherein the saddlebag includes a rear wall configured to face the motorcycle when the saddlebag is coupled to the motorcycle, and wherein the pocket is located on the rear wall and opens generally downwardly to receive the upwardly extending saddlebag attachment portion of the saddlebag frame.

12. The saddlebag mounting system of claim 1, wherein the saddlebag defines a length, and wherein the pocket extends along at least one quarter of the length of the saddlebag.

13. A motorcycle comprising:
a motorcycle frame including a rear fender support;
a rear fender coupled to the rear fender support;
a saddlebag frame coupled to the rear fender support, the saddlebag frame including a saddlebag attachment portion; and
a saddlebag including a body having a plurality of walls that define a cavity, and a pocket on at least one of the plurality of walls, the pocket receiving at least a portion of the saddlebag attachment portion to couple the saddlebag to the saddlebag frame.

14. The motorcycle of claim 13, wherein the saddlebag frame includes a mounting portion coupled to the rear fender support, an extension portion coupled to and extending from the mounting portion away from the motorcycle, wherein the saddlebag attachment portion extends upwardly with respect to the extension portion, and wherein the pocket opens generally downwardly such that the pocket receives a portion of the saddlebag attachment portion of the saddlebag frame.

15. The motorcycle of claim 13, wherein the motorcycle frame defines a longitudinal plane that extends longitudinally through the center of the motorcycle frame, and wherein the rear fender support is between a side wall of the rear fender and the longitudinal plane.

16. The motorcycle of claim 15, wherein the saddlebag frame includes a mounting portion coupled to the rear fender support, and wherein the mounting portion is disposed between the side wall of the rear fender and the rear fender support.

17. The motorcycle of claim 13, wherein the saddlebag frame includes a mounting portion that includes a first aperture and a second aperture, the first and second apertures each configured to receive a fastener to couple the saddlebag frame to the rear fender support, and wherein the first aperture extends through a first plane defined by the mounting portion and the second aperture extends through a second plane defined by the mounting portion that is offset from the first plane.

18. A saddlebag for use with a saddlebag frame having an attachment portion and configured to be coupled to a frame of a motorcycle, the saddlebag comprising:
a body having a plurality of walls that define a cavity; and
a pocket on at least one of the plurality of walls, the pocket configured to receive at least a portion of the saddlebag attachment portion to couple the saddlebag to the saddlebag frame.

19. The saddlebag of claim 18, wherein the saddlebag further includes a securing member configured to couple to a second saddlebag attachment portion of the saddlebag frame to couple the saddlebag to the saddlebag frame.

20. The saddlebag of claim 19, wherein the securing member includes a strap that at least partially wraps around a portion of the second saddlebag attachment portion of the saddlebag frame.

21. The saddlebag of claim 20, wherein the securing member further includes a clip to releaseably couple the saddlebag to the saddlebag frame.

22. The saddlebag of claim 18, wherein the saddlebag includes a rear wall configured to face the motorcycle when the saddlebag is coupled to the motorcycle, and wherein the pocket is located on the rear wall and opens generally downwardly such that the pocket is configured to receive the saddlebag attachment portion of the saddlebag frame.
